(19) United States
(12) Patent Application Publication
(10) Pub. No.: US 2022/0373461 A1
(43) Pub. Date: Nov. 24, 2022

(54) RECORDING APPARATUS

(71) Applicant: CANON KABUSHIKI KAISHA, Tokyo (JP)

(72) Inventor: Takaya Sato, Tokyo (JP)

(21) Appl. No.: 17/743,845

(22) Filed: May 13, 2022

(30) Foreign Application Priority Data
May 21, 2021 (JP) 2021-086091

(51) Int. Cl. G01N 21/59; B41J 2/175

(52) U.S. Cl. CPC G01N 21/5907; B41J 2/17566; B41J 2/17596

(57) ABSTRACT

A recording apparatus includes a channel through which liquid to be supplied to a recording head that ejects the liquid flows and a concentration measuring unit including a light emitting unit and a light receiving unit and configured to measure the concentration of the liquid, wherein the concentration measuring unit is disposed at a direction change portion at which the liquid flowing through the channel changes in direction.

### BACKGROUND

### Field of the Disclosure

The present disclosure relates to recording apparatuses that record images.

### Description of the Related Art

Ink-jet recording apparatuses are capable of recording high-definition images on recording media by ejecting ink or the like from a recording head. The ink used as a recording material may increase in concentration to affect the image quality when a water content in the ink evaporates.

Japanese Patent Laid-Open No. 2019-18441 discloses a configuration in which ink is made to flow through a channel in an optical cell made of a light-transmissive substance, and the amount of light passing through the ink is measured with a light-emitting element and a light-receiving element opposed on the opposite sides of the channel, and the ink is diluted according to the result of measurement.

However, with the configuration disclosed in Japanese Patent Laid-Open No. 2019-18441, the ink flows in the direction of the tangent to the wall surface of the channel in the optical cell, which may decrease the flow rate in the vicinity of the channel wall surface irradiated with the light from the light emitting element. The decrease in flow rate can cause the ink component, such as pigment, to be adsorbed or attached to the channel wall surface, hindering the ability to obtain the result of the concentration measurement with sufficient accuracy.

### SUMMARY

The present disclosure provides a recording apparatus capable of concentration measurement with high accuracy.

A recording apparatus according to an aspect of the present disclosure includes a channel through which liquid to be supplied to a recording head that ejects the liquid flows and a concentration measuring unit including a light emitting unit and a light receiving unit and configured to measure the concentration of the liquid, wherein the concentration measuring unit is disposed at a direction change portion at which the liquid flowing through the channel changes in direction.

Further features of the present disclosure will become apparent from the following description of exemplary embodiments with reference to the attached drawings.

### BRIEF DESCRIPTION OF THE DRAWINGS

FIG. 1 is a schematic front view of a recording system according to a first embodiment of the present disclosure.

FIG. 2 is a perspective view of a recording unit according to the first embodiment.

FIG. 3 is a diagram illustrating the displacement of the recording unit according to the first embodiment.

FIG. 4 is a block diagram of a control system of a recording system according to the first embodiment.

FIG. 5 is a block diagram of the control system of the recording system according to the first embodiment.

FIG. 6 is a diagram illustrating an example of the operation of the recording system according to the first embodiment.

FIG. 7 is a diagram illustrating an example of the operation of the recording system according to the first embodiment.

FIG. 8 is a schematic diagram illustrating the detailed configuration of a supply unit according to the first embodiment.

FIG. 9 is an enlarged schematic diagram illustrating, in outline, the configuration of a concentration measuring unit according to the first embodiment.

FIG. 10 is a flowchart of control for measurement of ink concentration according to the first embodiment.

FIG. 11 is a schematic diagram illustrating the detailed configuration of a supply unit according to a second embodiment.

FIG. 12 is an enlarged schematic diagram illustrating, in outline, the configuration of a concentration measuring unit according to the second embodiment.

FIG. 13 is a schematic diagram illustrating the detailed configuration of a supply unit according to a third embodiment.

FIG. 14 is an enlarged schematic diagram illustrating, in outline, the configuration of a concentration measuring unit according to the third embodiment.

FIG. 15 is a schematic diagram illustrating the detailed configuration of a supply unit according to a fourth embodiment.

FIG. 16 is an enlarged schematic diagram illustrating, in outline, the configuration of a concentration measuring unit according to the fourth embodiment.

FIG. 17 is a schematic diagram illustrating the detailed configuration of a supply unit according to a modification of the fourth embodiment.

FIG. 18 is a schematic diagram illustrating the detailed configuration of a supply unit according to a fifth embodiment.

FIG. 19 is a schematic diagram illustrating the detailed configuration of a supply unit according to a sixth embodiment.

FIG. 20 is an enlarged schematic diagram illustrating, in outline, the configuration of a concentration measuring unit according to the sixth embodiment.

### DESCRIPTION OF THE EMBODIMENTS

Embodiment of the present disclosure will be described hereinbelow with reference to the drawings. It is to be understood that the following embodiments do not limit the present disclosure and that not all of the combinations of the features described in the embodiments are absolutely necessary for the solution of the present disclosure. It is also to be understood that the relative positions, shapes, and so on of the components described in the embodiments are given for illustrative purposes only and the scope of the present disclosure is not limited thereto. In the drawings, arrows X and Y indicate horizontal directions perpendicular to each other, and arrow Z indicates the vertical direction.

### Recording System

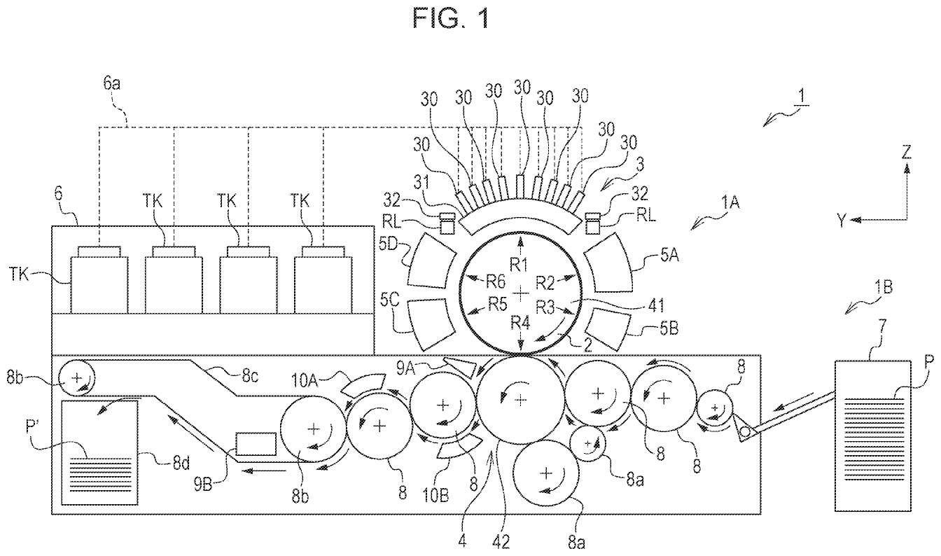

FIG. 1 is a schematic front view of a recording system 1 according to an embodiment of the present disclosure. The recording system 1 is a sheet-feed ink-jet printer (ink-jet recording apparatus) that produces a recorded material P′ by transferring an ink image to a recording medium P via a transfer body 2. The recording system 1 includes a recording apparatus 1A and a conveying apparatus 1B. In this embodiment, the X-direction, the Y-direction, and the Z-direction indicate the depth direction, the width direction (the longitudinal direction), and the height direction of the recording system 1, respectively. The recording medium P is conveyed in the Y-direction.

The term “recording” includes not only forming characters, figures, or other significant information but also forming images, designs, or patterns on recording media and processing media, regardless of whether they are significant, which may or may not be manifested so that humans can see they. In the embodiments, “recording medium” is supposed to be sheet-like paper but may be cloth, plastic film, or other materials.

The ink may contain any component, but in this embodiment, it is aqueous pigment ink containing a coloring material, water, and resin.

### Recording Apparatus

The recording apparatus 1A includes a recording unit 3, a transfer unit 4, peripheral units 5A to 5D, and a supply unit 6.

### Recording Unit

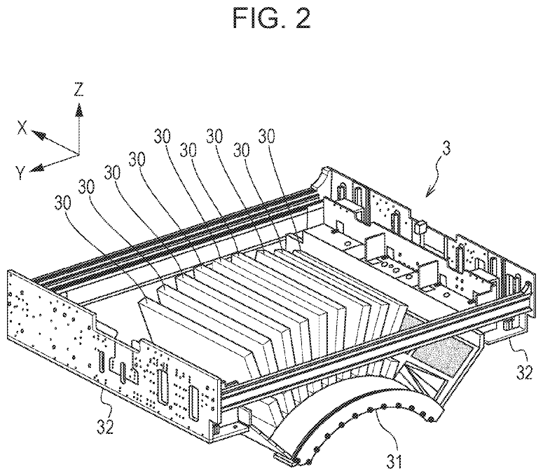

The recording unit 3 includes a plurality of recording heads 30 and a carriage 31. Refer to FIGS. 1 and 2. FIG. 2 is a perspective view of the recording unit 3. The recording heads 30 eject ink serving as liquid to the transfer body 2 to form an ink image of a record image on the transfer body 2.

In this embodiment, each recording head 30 is a full-line recording head extending in the X-direction, which includes nozzles arranged in the range that covers the width of the image recording area of the recording medium with an available maximum size. The recording head 30 has an ink ejection surface at an end in which nozzles are open. The ink ejection surface faces the surface of the transfer body 2 with a minute gap (for example, a few millimeters) therebetween. In this embodiment, the transfer body 2 moves cyclically on a circular orbit, so that the plurality of recording heads 30 are arranged radially.

Each nozzle includes an ejection element. An example of the ejection element ejects ink in the nozzle by generating pressure in the nozzle, to which a known technique of an ink-jet recording head of an ink-jet recorder is applicable. Examples of the ejection element include an element that ejects ink by causing film boiling in the ink with an electrothermal converter to form air bubbles, an element that ejects ink with an electromechanical converter, and an element that ejects ink using static electricity. From the viewpoint of high-speed high-density recording, an ejection element using an electrothermal converter can be used.

In this embodiment, the number of recording heads 30 is nine. The recording heads 30 eject different kinds of ink. Examples of the different kinds of ink include ink of different color materials, for example, a yellow ink, a magenta ink, a cyan ink, and a black ink. Each recording head 30 ejects one kind of ink but may eject two or more kinds of ink. In the case where a plurality of recording heads 30 is provided, part of which may eject an ink containing no coloring material (for example, a clear ink).

The carriage 31 supports the plurality of recording heads 30. Each recording head 30 is fixed to the carriage 31 at an end adjacent to the ink ejection surface. This allows the clearance between the ink ejection surface and the surface of the transfer body 2 to be kept more accurately. The carriage 31 is displaceably guided by a pair of guide members RL with the recording heads 30 mounted thereon. In this embodiment, the guide members RL are rail members extending in the X-direction and disposed away from each other in the Y-direction. Sliding units 32 are provided on opposite sides in the Y-direction of the carriage 31. The sliding units 32 engage with the guide members RL and slide in the X-direction along the guide members RL.

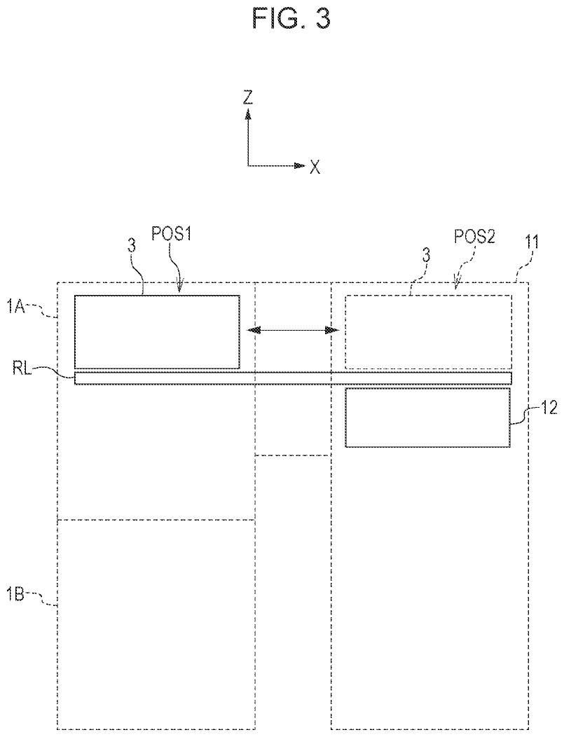

FIG. 3 is a diagram illustrating the displacement of the recording unit 3, schematically illustrating the right side of the recording system 1. The recording system 1 includes a rear unit 11 at the rear. The rear unit 11 includes a recovery unit 12. The recovery unit 12 includes a mechanism for recovering the ejection performance of the recording head 30. Examples of the recovery mechanism include a capping mechanism for capping the ink ejection surface of the recording head 30, a wiper mechanism for wiping the ink ejection surface, and a suction mechanism for sucking remaining ink in the recording head 30 through the ink ejection surface under negative pressure.

The guide members RL extend from the sides of the transfer body 2 over the recovery unit 12. The recording unit 3 can be displaced by the guide of the guide members RL between an ejecting position POS1 indicated by the solid line and a recovery position POS2 indicated by the broken line by a driving mechanism (not shown). The ejecting position POS1 is a position at which the recording unit 3 ejects ink to the transfer body 2 and at which the ink ejection surface of the recording head 30 faces the surface of the transfer body 2. The recovery position POS2 is a position retracting from the ejecting position POS1 and at which the recording head 30 is located above the recovery unit 12. The recovery unit 12 can recover the recording head 30 when the recording unit 3 is located at the recovery position POS2.

### Transfer Unit

Referring to FIG. 1, the transfer unit 4 will be described. The transfer unit 4 includes a transfer cylinder 41 and an impression cylinder 42. These cylinders are rotational members that rotate about the axis of rotation in the X-direction and have a cylindrical outer circumferential surface. In FIG. 1, the arrows in the transfer cylinder 41 and the impression cylinder 42 indicate the directions of rotation. The transfer cylinder 41 rotates clockwise, and the impression cylinder 42 rotates counterclockwise.

The transfer cylinder 41 is a supporting member that supports the transfer body 2 around the outer circumferential surface. The transfer body 2 is provided continuously or intermittently around the outer circumferential surface of the transfer cylinder 41. With the continuous configuration, the transfer body 2 has an endless belt shape. With the intermittent configuration, the transfer body 2 is formed into a plurality of segments in an ended belt shape. The segments may be arranged at a regular pitch around the outer circumferential surface of the transfer cylinder 41.

The transfer body 2 moves on the circular orbit cyclically as the transfer cylinder 41 rotates. The position of the transfer body 2 can be differentiated among a forming region R1, pre-transfer processing regions R2 and R3, a transfer region R4, a post-transfer processing region R5, and a pre-ejection processing region R6 according to the rotation phase of the transfer cylinder 41. The transfer body 2 passes through these regions cyclically.

The forming region R1 is a region in which the recording unit 3 ejects ink to the transfer body 2 to form an ink image. The pre-transfer processing regions R2 and R3 are processing regions in which the ink image is processed before being transferred, of which the pre-transfer processing region R2 is a region in which the ink image is processed by the peripheral unit 5A, and the pre-transfer processing region R3 is a region in which the ink image is processed by the peripheral unit 5B. The transfer region R4 is a region in which the ink image on the transfer body 2 is transferred to the recording medium P by the transfer unit 4. The post-transfer processing region R5 is a region in which post-processing is performed on the transfer body 2 by the peripheral unit 5C after the transfer. The pre-ejection processing region R6 is a region in which preprocessing (in this embodiment, application of reaction liquid) is performed on the transfer body 2 by the peripheral unit 5D.

In this embodiment, the forming region R1 includes a certain section, and the other regions R2 to R6 are substantially point (in other words, line) regions. On a clock face, for example, in this embodiment, the forming region R1 is generally the range from 11:00 to 1:00, the pre-transfer processing region R2 is generally the position of 2:00, and the pre-transfer processing region R3 is generally the position of 4:00. The transfer region R4 is generally the position of 6:00, the post-transfer processing region R5 is generally the position of 8:00, and the pre-ejection processing region R6 is generally the position of 10:00.

The transfer body 2 may be constituted of a single layer or a laminate of multiple layers. With the configuration of multiple layers, the transfer body 2 may include three layers: a surface layer, an elastic layer, and a compressive layer. The surface layer is the outermost layer including an image formed surface on which an ink image is formed. The compressive layer can absorb deformation and disperse local pressure fluctuations to maintain the transfer performance even in high-speed recording. The elastic layer is disposed between the surface layer and the compressive layer.

The surface layer may be made of resin, ceramic, or another appropriate material, and in terms of durability, may be made of a material with a high compressive elastic modulus. Specific examples include an acrylic resin, an acrylic silicone resin, a fluoride-containing resin, and a condensate product obtained by condensing a hydrolyzable organosilicon compound. The surface layer may be surface-treated to improve the wettability, transfer performance, and so on of the reaction liquid. Examples of the surface treatment include frame processing, corona treatment, plasma treatment, polishing, roughening, activation-energy-ray radiation processing, ozonation treatment, surfactant treatment, silane coupling treatment, and a combination thereof. The surface layer may have any surface shape.

Example materials for the compressive layer include acrylonitrile-butadiene rubber, acrylic rubber, chloroprene rubber, urethane rubber, and silicone rubber. In forming such rubber materials, a predetermined amount of a vulcanizing agent or a vulcanizing accelerator is added, and a foaming agent and a filler such as hollow fine particles or salt may be mixed as necessary to form a porous rubber material. This allows the bubble portion to be compressed with volume changes due to various pressure fluctuations, reducing deformation in directions other than the compressing direction to provide stable transfer performance and durability. The porous rubber material may have a continuous air hole structure in which air holes continue, an independent air hole structure in which air holes are independent from each other, or a combination thereof.

Example materials for the elastic layer include resin and ceramics. In terms of processing characteristics, various elastomer materials and rubber materials may be used. Specific examples include fluorosilicone rubber, phenylsilicone rubber, fluorine-containing rubber, chloroprene rubber, urethane rubber, and nitrile rubber. Other examples include ethylene-propylene rubber, natural rubber, styrene rubber, isoprene rubber, butadiene rubber, ethylene-propylene-butadiene copolymer, and nitrile-butadiene rubber. In particular, silicone rubber, fluorosilicone rubber, and phenylsilicone rubber have an advantage in terms of dimensional stability and durability because of their small compression set. They have an advantage also in terms of transfer performance because of their small change in elastic modulus with temperature.

Various adhesives or double-face tape may be provided between the surface layer and the elastic layer and between the elastic layer and the compressive layer. The transfer body 2 may include a reinforcement layer with a high compressive elastic modulus to prevent lateral extension when mounted to the transfer cylinder 41 and to keep firmness. Fabric cloth may be used for the reinforcement layer. The transfer body 2 may be produced by freely combining the above layers made of the above materials.

The outer circumferential surface of the impression cylinder 42 is pressed against the transfer body 2. The outer circumferential surface of the impression cylinder 42 is provided with at least one grip mechanism for holding the leading end of the recording medium P. A plurality of grip mechanisms may be disposed away from each other in the circumferential direction of the impression cylinder 42. The ink image on the transfer body 2 is transferred to the recording medium P when the recording medium P passes through the nip portion between the impression cylinder 42 and the transfer body 2 while being conveyed in close-contact with the outer circumferential surface of the impression cylinder 42.

### Peripheral Unit

The peripheral units 5A to 5D are arranged around the transfer cylinder 41. In this embodiment, the peripheral units 5A to 5D are an absorbing unit, a heating unit, a cleaning unit, an applying unit in this order.

The absorbing unit 5A is a mechanism for absorbing a liquid component from the ink image on the transfer body 2 before transfer, and in this embodiment, it is a mechanism for absorbing a water content from the ink image.

Reducing the water content in the ink image prevents the bleeding or the like of the image to be recorded on the recording medium P. For example, the absorbing unit 5A includes an absorbing member that comes into contact with the ink image to decrease the water content in the ink image. The absorbing member may be disposed on the outer circumferential surface of the roller or may be an endless sheet that is run cyclically. In the viewpoint of protection of the ink image, the absorbing member may be moved in synchronism with the transfer body 2 or at the same circumferential velocity as that of the transfer body 2. The absorbing member may contain a porous material that comes into contact with the ink image. The average pore diameter of the porous material may be 10 μm or less to prevent adhesion of the solid content of the ink.

The heating unit 5B is a mechanism for heating the ink image on the transfer body 2 before transfer. Heating the ink image melts the resin in the ink image to form the film of the ink image, improving the performance of transfer to the recording medium P. The heating temperature can be set to the minimum film forming temperature (MFT) or more. The MFT can be measured using a known method with an apparatus based on, for example, JIS K 6828-2:2003 or ISO 2115:1996. The heating temperature may be 10° C. or higher or 20° C. or higher than the MFT in the viewpoint of the transfer performance and the fastness of the image. Examples of the heating unit 5B include various kinds of lamp, such as an infrared lamp, a hot-air fan, and other known heating devices. An infrared heater may be used in terms of heating efficiency.

The cleaning unit 5C is a mechanism for cleaning the top of the transfer body 2 after transfer. The cleaning unit 5C removes the ink remaining on the transfer body 2, dust (for example, paper dust) on the transfer body 2, and so on. The cleaning unit 5C may employ a method of bringing a porous member into contact with the transfer body 2, a method of rubbing the surface of the transfer body 2 with a blush, a method of scraping the surface of the transfer body 2 with a blade, or another known method. The cleaning member may have a roller shape, a web shape, or any other known shape.

The applying unit 5D is a mechanism for applying reaction liquid onto the transfer body 2 after cleaning with the cleaning unit 5C and before ejection of ink with the recording unit 3. The reaction liquid accelerates coagulation of the coloring material and contains a component that increases the viscosity of ink. Examples of the ink-viscosity increasing component include metal ions, a high-polymer coagulant, a substance that changes the pH of the ink to coagulate the coloring material in the ink, such as organic acid, and any other components.

Examples of the reaction-liquid application mechanism include a roller, a recording head, a die coating unit (die coater), and a blade coating unit (blade coater). Applying reaction liquid to the transfer body 2 before ejecting ink to the transfer body 2 prevents bleeding in which adjacent inks mix with each other and breading in which the ink that lands first is attracted to the ink that lands after it.

Thus, this embodiment includes the absorbing unit 5A, the heating unit 5B, the cleaning unit 5C, and the applying unit 5D as peripheral units. In addition, a cooling function for the transfer body 2 may be provided to some of the above units, or a cooling unit may be provided. In this embodiment, the temperature of the transfer body 2 can be increased by the heat from the heating unit 5B. If the temperature of the ink image exceeds the boiling point of water, which is the main solvent of the ink, after the recording unit 3 ejects ink to the transfer body 2, the water-content absorption performance of the absorbing unit 5A may be degraded. The water-content absorption performance can be maintained by cooling the transfer body 2 so that the ejected ink is maintained below the boiling point of water.

The cooling unit may be a blowing mechanism for blowing air to the transfer body 2 or a mechanism for bringing a member (for example, a roller) into contact with the transfer body 2 and cooling the member with air or water. The cooling unit may be a mechanism for cooling the cleaning member of the cleaning unit 5C. Cooling timing may be a period from transfer to application of reaction liquid.

### Supply Unit

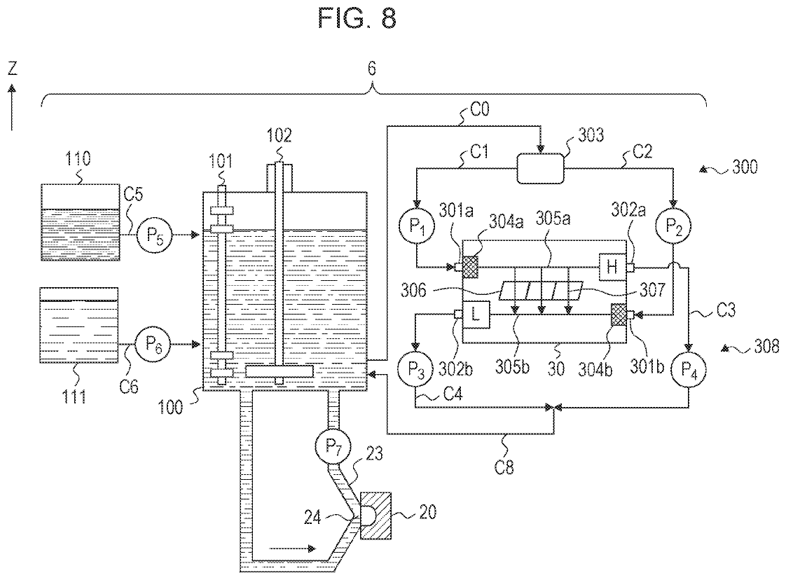

The supply unit 6 is a mechanism for supplying ink to the individual recording heads 30 of the recording unit 3. The supply unit 6 may be provided at the rear unit 11. The supply unit 6 includes a reservoir TK that stores ink for each kind of ink. The reservoir TK may include an ink tank 110 and a buffer tank 100 that stores ink supplied from the ink tank 110 (see FIG. 8). Alternatively, the reservoir TK may include only the buffer tank 100 that stores ink supplied from an ink tank 110 provided outside the recording apparatus 1A. Each reservoir TK and each recording head 30 communicate through a channel 6a to supply ink from the reservoir TK to the recording head 30.

The channel 6a may circulate the ink between the reservoir TK and the recording head 30. The supply unit 6 may include a pump that circulates the ink. A deaeration mechanism that expels air bubbles in the ink may be provided at an intermediate point in the channel 6a or at the reservoir TK. A valve that adjusts the pressure of the ink and atmospheric pressure may be provided at an intermediate point in the channel 6a or at the reservoir TK.

The heights of the reservoir TK and the recording head 30 in the Z-direction may be designed so that the level of the ink in the reservoir TK is lower than the ink ejection surface of the recording head 30.

### Conveying Apparatus

The conveying apparatus 1B conveys the recording medium P to the transfer unit 4 and discharges the recorded material to which an ink image is transferred, from the transfer unit 4. The conveying apparatus 1B includes a feeding unit 7, a plurality of conveying cylinders 8 and 8a, two sprockets 8b, a chain 8c, and a collection unit 8d. In FIG. 1, the arrows inside the components of the conveying apparatus 1B indicate the directions of rotation of the components, and the arrows outside indicate the conveying path of the recording medium P or the recorded material The recording medium P is conveyed from the feeding unit 7 to the transfer unit 4, and the recorded material P′ is conveyed from the transfer unit 4 to the collection unit 8d. The feeding unit 7 side may be referred to as “upstream side” in the conveying direction, and the collection unit 8d side may be referred to as “downstream side”.

The feeding unit 7 includes a stacking unit in which a plurality of recording media P is stacked and a feeding mechanism that feeds the recording media P one by one from the stacking unit to the uppermost stream conveying cylinder 8. The conveying cylinders 8 and 8a are rotational member that rotates about the rotation axis in the X-direction and has a cylindrical outer circumferential surface. The conveying cylinders 8 and 8a each include at least one grip mechanism for holding the leading end of the recording medium P (or the recorded material P′) on the outer circumferential surface. The grip operation and the releasing operation of each grip mechanism is controlled so that the recording medium P (or the recorded material P′) is transferred between adjacent conveying cylinders.

The two conveying cylinders 8a are used to reverse the recording medium P and, in one-sided recording, not used to convey the recording medium P. In two-sided recording, the recording medium P is conveyed from the impression cylinder 42 to the conveying cylinder 8a, not to the conveying cylinder 8 adjacent on the downstream side. The recording medium P is revered front to back through the two conveying cylinders 8a and is conveyed back to the impression cylinder 42 via the conveying cylinder 8 upstream from the impression cylinder 42. This causes the back side of the recording medium P to face the transfer cylinder 41, so that the ink image is transferred to the back side.

The chain 8c is wound between the two sprockets 8b. One of the two sprockets 8b is a driving sprocket, and the other is a driven sprocket. The rotation of the driving sprocket causes the chain 8c to run cyclically. The chain 8c includes a plurality of grip mechanisms disposed away from each other in the longitudinal direction. The grip mechanism grips an end of the recorded material P′. The recorded material P′ is passed from the conveying cylinder 8 at the downstream end to the grip mechanism at the chain 8c, and the recorded material gripped by the grip mechanism is conveyed to the collection unit 8d by the running of the chain 8c, where the grip is released. Thus, the recorded material is stacked in the collection unit 8d.

### Post-Processing Unit

The conveying apparatus 1B includes post-processing units 10A and 10B. The post-processing units 10A and 10B are disposed downstream from the transfer unit 4 and post-process the recorded material The post-processing unit 10A processes the front of the recorded material and the post-processing unit 10B processes the back of the recorded material P′. An example of the processing is coating the image recording surface of the recorded material P′ to protect and glaze the image. Examples of the coating include application of liquid, welding of the sheet, and lamination.

### Inspection Unit

The conveying apparatus 1B includes inspection units 9A and 9B. The inspection units 9A and 9B are disposed downstream from the transfer unit 4 and inspect the recorded material P′.

In this embodiment, the inspection unit 9A is an image capturing unit that captures an image of the image recorded on the recorded material for example, an image sensor, such as a charge-coupled device (CCD) sensor or a complementary metal-oxide semiconductor (CMOS) sensor. The inspection unit 9A captures images of the recorded image during a continuous recording operation. A determination whether to correct the record data can be made by checking the temporal change in the color and the like of the recorded image on the basis of the images captured by the inspection unit 9A. In this embodiment, the image-capturing range of the inspection unit 9A is set on the outer circumferential surface of the impression cylinder 42 so as to capture part of the recorded image directly after transfer.

The inspection unit 9A may inspect all of the recorded images or inspect the recorded images at intervals of a predetermined number.

In this embodiment, also the inspection unit 9B is an image capturing unit that captures the image recorded on the recorded material for example, an image sensor, such as a CCD sensor or a CMOS sensor. The inspection unit 9B captures an image of the recorded image in a test recording operation. The inspection unit 9B captures the whole image of the recorded image, and basic setting for various corrections of the record data can be performed on the basis of the image captured by the inspection unit 9B. In this embodiment, the inspection unit 9B is disposed at a position where an image of the recorded material P′ conveyed by the chain 8c can be captured. In capturing the image of the recorded image, the inspection unit 9B captures the whole of the recording image, with the running of the chain 8c temporarily stopped. The inspection unit 9B may be a scanner that scans the recorded material P′.

### Control Unit

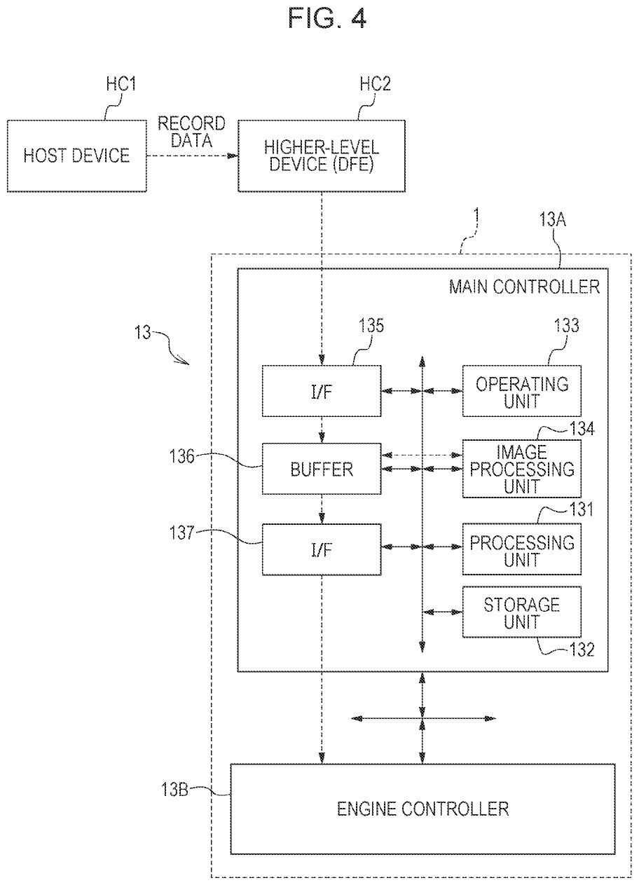

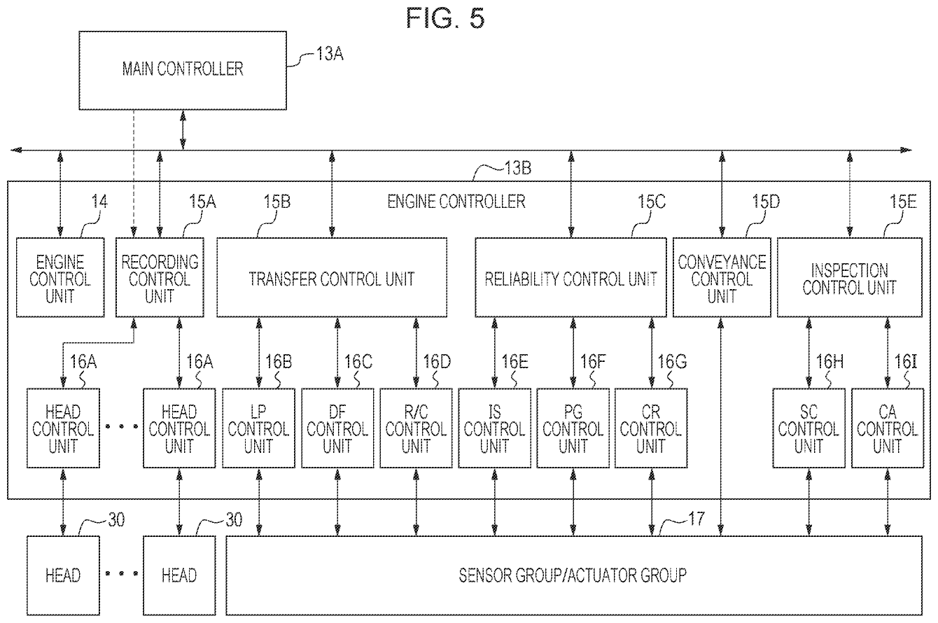

Next, the control unit of the recording system 1 will be described. FIGS. 4 and 5 are block diagrams of the control unit 13 of the recording system 1. The control unit 13 is communicably connected to a higher-level device HC2 (a digital front end processor (DFE)). The higher-level device HC2 is communicably connected to a host device HC1.

The host device HC1 generates record data, which is the source of the recorded image. The record data is generated in the format of an electronic file, such as a document file or an image file. The record data is sent to the higher-level device HC2. The higher-level device HC2 converts the received record data to a data format that is available in the control unit 13 (for example, CMYK color data). The converted record data is transmitted from the higher-level device HC2 to the control unit 13. The control unit 13 starts a recording operation on the basis of the received record data.

In this embodiment, the control unit 13 is roughly divided into a main controller 13A and an engine controller 13B. The main controller 13A includes a processing unit 131, a storage unit 132, an operating unit 133, an image processing unit 134, a communication interface (I/F) 135, a buffer 136, and a communication I/F 137.

The processing unit 131 is a processor, such as a central processing unit (CPU), which executes programs stored in the storage unit 132 to control the entire main controller 13A. The storage unit 132 is a storage device, such as a random-access memory (RAM), a read-only memory (ROM), a hard disk, or a solid-state drive (SSD), which stores programs to be executed by the CPU 131 and data and provides a work area to the CPU 131. The operating unit 133 is an input device, such as a touch panel, a keyboard, or a mouse, and receives user's instructions.

An example of the image processing unit 134 is an electronic circuit including an image processor. Examples of the buffer 136 include a RAM, a hard disk, and an SSD. The communication I/F 135 communicates with the higher-level device HC2. The communication I/F 137 communicates with the engine controller 13B.

In FIG. 4, the dashed arrow indicates the flow of processing of the record data. The record data received from the higher-level device HC2 via the communication I/F 135 is stored in the buffer 136. The image processing unit 134 reads the record data from the buffer 136, performs predetermined image processing on the read record data, and stores the processed record data in the buffer 136 again. The image-processed record data stored in the buffer 136 is transmitted to the engine controller 13B via the communication I/F 137.

As shown in FIG. 5, the engine controller 13B includes control units 15A to 15E and 16A to 161 and obtains the detection results of a sensor group and an actuator group 17 of the recording system 1 and controls the driving of them. These control units include a processor, such as a CPU, storage devices, such as a RAM and a ROM, and an interface to an external device. The classification of the control units is illustrative only. Some control may be executed by a plurality of subdivided control units, or in contrast, a plurality of control units may be integrated, with which the processes thereof may be executed.

An engine control unit 14 controls the entire engine controller 13B. The recording control unit 15A controls the recording-head control unit 16A provided for each recording head 30. The recording control unit 15A also converts record data received from the main controller 13A to a data format suitable for driving the recording head 30, such as raster data. Each recording-head control unit 16A controls the ejection of the corresponding recording head 30.

The transfer control unit 15B controls the LP control unit 16B, the DF control unit 16C, and the R/C control unit 16D. The LP control unit 16B controls the absorbing unit 5A. The DF control unit 16C controls the heating unit 5B. The R/C control unit 16D controls the cleaning unit 5C and the applying unit 5D.

The reliability control unit 15C controls the IS control unit 16E, the PG control unit 16F, and the CR control unit 16G. The IS control unit 16E controls the supply unit 6. The PG control unit 16F controls the recovery unit 12. The CR control unit 16G controls the driving mechanism that drives the recording unit 3 between the ejecting position POS1 and the recovery position POS2.

The conveyance control unit 15D controls the conveying apparatus 1B. The inspection control unit 15E controls the SC control unit 16H and the CA control unit 161. The SC control unit 16H controls the inspection unit 9B. The CA control unit 161 controls the inspection unit 9A.

Of the sensor group and the actuator group 17, the sensor group includes a sensor that detects the position and the speed of a movable member, a sensor that detects the temperature, and an image sensor, and the actuator group includes a motor, an electromagnetic solenoid, and an electromagnetic valve.

### Operation Examples

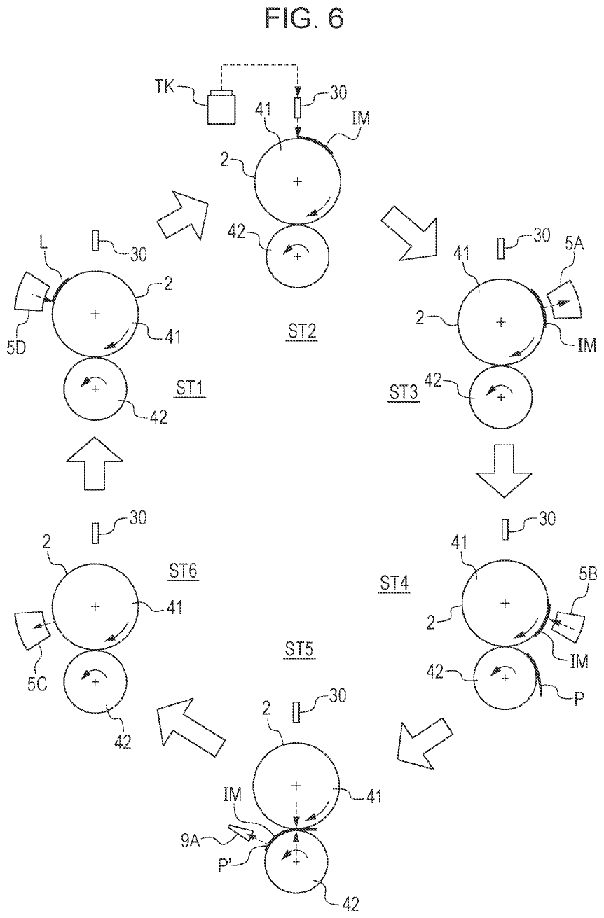

FIG. 6 is a schematic diagram illustrating an example of the recording operation. The following processes are cyclically performed while the transfer cylinder 41 and the impression cylinder 42 are being rotated. First, reaction liquid L is applied from the applying unit 5D onto the transfer body 2, as shown in state ST1. The portion on the transfer body 2 to which the reaction liquid L is applied moves with the rotation of the transfer cylinder 41. When the portion to which the reaction liquid L is applied reaches below the recording head 30, ink is ejected from the recording head 30 to the transfer body 2, as shown in state ST2. Thus, an ink image IM is formed. At that time, the ejected ink mixes with the reaction liquid L on the transfer body 2 to accelerate the coagulation of the coloring material. The ink to be ejected is supplied from the reservoir TK of the supply unit 6 to the recording head 30.

The ink image IM on the transfer body 2 moves with the rotation of the transfer body 2. When the ink image IM reaches the absorbing unit 5A, the water content is absorbed from the ink image IM by the absorbing unit 5A, as shown in state ST3. When the ink image IM reaches the heating unit 5B, the ink image IM is heated by the heating unit 5B, as shown in state ST4, so that the resin in the ink image IM melts to form the film of the ink image IM. In synchronization with the formation of the ink image IM, the recording medium P is conveyed by the conveying apparatus 1B.

The ink image IM and the recording medium P reach the nip portion between the transfer body 2 and the impression cylinder 42, as shown in state ST5, where the ink image IM is transferred to the recording medium P to produce the recorded material P′. After the recorded material P′ passes through the nip portion, the image recorded on the recorded material P′ is captured by the inspection unit 9A, where the recorded image is inspected. The recorded material P′ is conveyed to the collection unit 8d by the conveying apparatus 1B.

The portion on the transfer body 2 on which the ink image IM is formed is cleaned by the cleaning unit 5C after reaching the cleaning unit 5C, as shown in state ST6. After the cleaning, the transfer body 2 have made one rotation, and the transfer of the ink image IM to the recording medium P is repeated in a similar procedure. In the above example, the ink image IM is transferred to one recording medium P by one rotation of the transfer body 2, for ease of understanding. Alternatively, the ink image IM may be transferred continuously to a plurality of recording media P by one rotation of the transfer body 2.

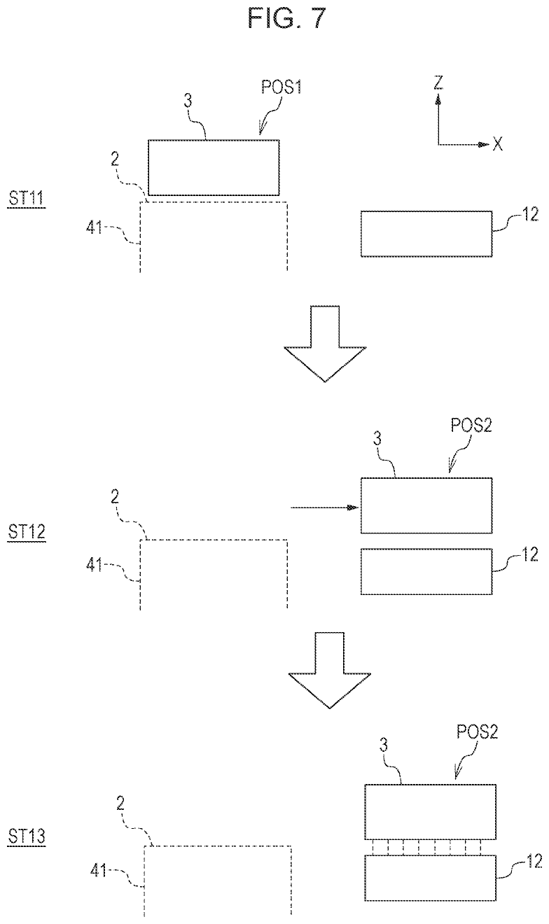

Continuation of such a recording operation needs maintenance of the recording heads 30. FIG. 7 illustrates an operation example at the maintenance of each recording head 30. State ST11 shows a state in which the recording unit 3 is positioned at the ejecting position POS1. State ST12 shows a state in which the recording unit 3 is displaced to the recovery position POS2. Thereafter, the recovery unit 12 executes the process of recovering the performance of each recording head 30 of the recording unit 3, as shown in state ST13.

### First Embodiment

FIG. 8 is a schematic diagram illustrating the detailed configuration of the supply unit 6 employed in the recording apparatus 1A. Although FIG. 8 illustrates one supply unit 6 corresponding to one color ink, supply units 6 corresponding to the number of inks used in the recording apparatus 1A are actually provided. In the supply unit 6, the ink circulates between the buffer tank 100 and the recording head 30. The recording head 30 ejects ink on the basis of the image data, and remaining ink not ejected is collected in the buffer tank 100.

The ink tank 110 stores the ink to be supplied to the buffer tank 100 and is detachable to the recording apparatus 1A main body. The ink may be supplied from the ink tank 110 to the buffer tank 100 on the basis of an instruction from the IS control unit 16E or when the ink tank 110 is replaced. The ink tank 110 may include therein a stirrer for starring the ink and a detector for detecting the amount of ink stored. A tank connecting channel C5 that connects the buffer tank 100 to the ink tank 110 is provided with a pump Ps serving as a replenishing unit for supplying ink from the ink tank 110 to the buffer tank 100.

The buffer tank 100 includes therein a liquid-level detecting unit 101, such as a float switch or a capacitance sensor. When the liquid-level detecting unit 101 detects the amount of ink in the buffer tank 100 decreasing from a predetermined amount or when the concentration of the ink in the buffer tank 100 has changed from a predetermined concentration, the buffer tank 100 is replenished with ink from the ink tank 110. The ink tank 110 may further include therein a stirrer for stirring the ink and a detector for detecting the amount of ink stored.

The buffer tank 100 is a reservoir that stores the ink supplied from the ink tank 110. The buffer tank 100 connects to an upstream supply channel C0 for supplying ink from the buffer tank 100 to the recording head 30. The upstream supply channel C0 is split into a first supply channel C1 for supplying ink to a first inlet 301a of the recording head 30 and a second supply channel C2 for supplying ink to a second inlet 301b of the recording head 30.

The buffer tank 100 further connects to a downstream collecting channel C8 for collecting ink from the recording head 30. The downstream collecting channel C8 connects the buffer tank 100 to a portion at which a first collection channel C3 for collecting ink through a first collection port 302a of the recording head 30 and a second collection channel C4 for collecting ink through a second collection port 302b join together.

In other words, a circulation channel in which ink circulates is constituted by the buffer tank 100, the upstream supply channel C0, the first supply channel C1, the second supply channel C2, the recording head 30, the first collection channel C3, the second collection channel C4, and the downstream collecting channel C8. The upstream supply channel C0, the first supply channel C1, and the second supply channel C2 are collectively referred to as a supply channel 300. The first collection channel C3, the second collection channel C4, and the downstream collecting channel C8 are collectively referred to as a collection channel 308.

The buffer tank 100 includes a stirring unit 102 for stirring the ink in the tank 100. The stirring unit 102 makes the concentration of the ink uniform. The buffer tank 100 may include an atmosphere communication port (not shown) for communicating the interior of the tank with the outside so that the air bubbles in the ink can be discharged to the outside.

Of the supply channel 300, the first supply channel C1 is provided with a first supply pump P1, and the second supply channel C2 is provided with a second supply pump P2. The first supply pump Pi and the second supply pump P2 function as circulation units for circulating ink through the circulation channel while supplying ink to the recording head 30. The supply channel 300 may include a deaeration mechanism for expelling air bubbles in the ink and a temperature adjusting mechanism 303 for heating or cooling the temperature of the ink. The temperature adjusting mechanism 303 of this embodiment is disposed at the branch point of the upstream supply channel C0, the first supply channel C1, and the second supply channel C2.

The recording head 30 includes therein a pressure control mechanism for controlling the pressure of the ink flowing through the channel so that the pressure changes within a desired range. In this embodiment, the pressure control mechanism includes a high-pressure control unit H and a low-pressure control unit L that controls the pressure lower than that of the high-pressure control unit H.

The ink that has flowed into the recording head 30 through the first inlet 301a flows through a filter 304a and a common supply channel 305a and then flows out to the first collection channel C3 through the high-pressure control unit H and the first collection port 302a. The ink that has flowed into the recording head 30 through the second inlet 301b flows through a filter 304b and a common collection channel 305b passes through the low-pressure control unit L and flows out to the fourth collection channel C4 through the second collection port 302b.

The two pressure control mechanisms (the high-pressure control unit H and the low-pressure control unit L) and the two supply pumps (the first supply pump P1 and the second supply pump P2) control the pressures of the common supply channel 305a and the common collection channel 305b to differ from each other. This causes an ink flow from the common supply channel 305a to the common collection channel 305b through ejecting-portion channels 307 connecting to a plurality of ejecting portions 306 and part of ink supplied through the inlets 301a and 301b to flow to the collection ports 302a and 302b not through the ejecting portions 306. Each ejecting-portion channel 307 is a channel in which liquid passes near the opening of the ejecting portion 306. The circulation channels described above include the common supply channel 305a, the ejecting-portion channels 307, and the common collection channel 305b.

With this configuration, the water content of the ink that has passed near the ejecting portions 306 is vaporized because part thereof comes into contact with air. This causes a phenomenon in which the concentration of the ink circulating in the buffer tank 100 and the recording head 30 increases. The ink that has increased in concentration may affect the quality of the recorded image.

To prevent the phenomenon, a diluent tank 111 that stores a diluent for diluting the ink in the buffer tank 100 is connected to the buffer tank 100. The diluent tank 111 may be provided in the recording apparatus 1A or outside the recording apparatus 1A. In this embodiment, the diluent is pure water.

If the concentration of the ink in the buffer tank 100 is higher than a predetermined value, a diluent is supplied from the diluent tank 111 through a channel C6 using a pump P6 serving as a supply unit. This allows the concentration of the ink in the buffer tank 100 to be maintained at a concentration suitable for the recording operation performed by the recording head 30. A detector for detecting the amount of the diluent stored may be provided in the diluent tank 111. The diluent in the diluent tank 111 is supplied by a user or an operator appropriately.

### Concentration Measuring Unit

The buffer tank 100 connects to a concentration measuring unit 20 for measuring the concentration of the ink in the tank through a channel 23. The channel 23 is a transparent channel that transmits light and is made of quartz glass or sapphire glass, for example. The ink is circulated between the concentration measuring unit 20 and the buffer tank 100 by a pump P7 disposed in the channel 23.

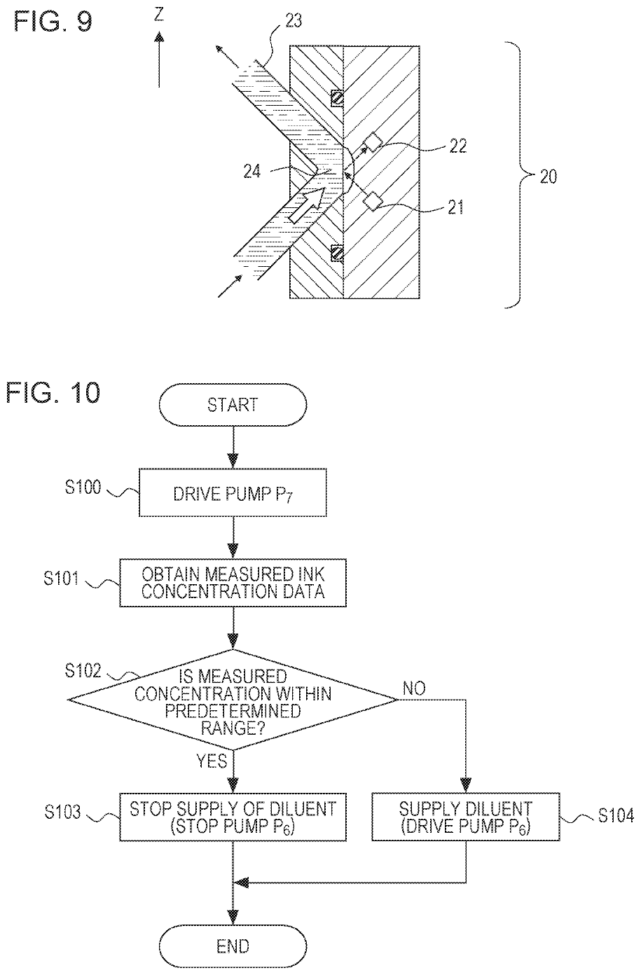

FIG. 9 is an enlarged schematic diagram illustrating, in outline, the configuration of the concentration measuring unit 20 according to this embodiment. The concentration measuring unit 20 is provided for each of the reservoirs TK shown in FIG. 1. A light radiating unit 21 is a light source (light emitting unit) that emits light, which is disposed at a position where the incident angle of the light that irradiates the channel 23 is about 45 degrees. A light receiving unit 22 may be disposed so that the position where the scattered light reflected via the channel 23 and the ink flowing through the channel 23 is at about 90 degrees with respect to the incident surface. The information on the received light (signal) is sent to the IS control unit 16E, and the IS control unit 16E derives the concentration of the ink from the value.

If the concentration of the ink is higher than the predetermined concentration, in order to receive the scattered light with the light receiving unit 22 with high accuracy, the radiated light from the light radiating unit 21 scattered in the vicinity of the wall of the channel 23, that is, backward-scattered light, needs to be received on the radiated light side. For that reason, the concentration measuring unit 20 has the above configuration.

When ink flows in the direction tangent to the wall surface of the channel 23 in the concentration measuring unit 20, the flow rate decreases in the vicinity of the wall surface. This can cause the ink component, such as pigment, to be attached to the channel wall surface, making it difficult to receive the reflected scattered light with sufficient accuracy. For this reason, this embodiment is configured such that the concentration measuring unit 20 is disposed at a direction change portion 24 of the channel 23 at which the ink flow direction is changed. Thus, the velocity of the ink flowing in the vicinity of the wall surface of the channel 23 at the concentration measuring unit 20 is higher than that when the concentration measuring unit 20 is disposed at the straight portion. This decreases the adsorption and attachment of the ink component, such as pigment, to the channel wall surface, allowing high-accuracy measurement of the ink concentration.

### Processing Procedure for Concentration Measurement

FIG. 10 is a flowchart of control for measurement of ink concentration. This process is achieved by the control unit of the recording apparatus (in this embodiment, the IS control unit 16E) reading and executing a program stored in the storage unit 132. This process may be executed at a predetermined timing or when a measurement instruction is given from the user or the like. The process may be performed in parallel with recording with the recording head 30.

In S100, the IS control unit 16E drives the pump P₇ so that the ink in the buffer tank 100 flows through the channel 23. In addition, the IS control unit 16E may control the pumps P₅ and P₆ to supply the ink and a diluent to the buffer tank 100 from the ink tank 110 and the diluent tank 111, respectively, to the extent that the concentration of the ink in the buffer tank 100 is not affected. For example, only one of the ink and the diluent may be supplied to the buffer tank 100, or the amount of supply of one of the ink and the diluent may be limited.

In S101, the IS control unit 16E controls the concentration measuring unit 20 to cause the concentration measuring unit 20 to measure the concentration of the ink passing through the concentration measuring unit 20. To reduce the adsorption and attachment of the ink component, such as pigment, in the vicinity of the wall surface of the channel 23, the ink in the channel 23 may be made to flow by driving the pump P₇ at the time of concentration measurement. However, depending on the color or composition of the ink, the adsorption and attachment to the wall surface of the channel 23 may be minor. For this reason, the driving of the pump P₇ is not essential requirement for measuring the concentration of all inks.

In S102, the IS control unit 16E determines whether the concentration measured in S101 is within a predetermined range. The predetermined range is specified in advance and is stored in the storage unit 132 or the like. The predetermined range is specified for each type and color of ink. If it is determined that the concentration is within the predetermined range (S102: YES), the process goes to S103, and if it is determined that the concentration is not within the predetermined range (S102: NO), the process goes to S104.

In S103, if a diluent is being supplied from the diluent tank 111, the IS control unit 16E stops the pump P₆ to stop the supply of the diluent. At that time, the concentration of the ink in the buffer tank 100 is appropriate. For this reason, if ink is being supplied from the ink tank 110, the IS control unit 16E also stops the supply of ink by controlling the pump P₅.

Then, the processing procedure ends.

In S104, the IS control unit 16E controls the pump P₆ so that the diluent is supplied from the diluent tank 111. If the diluent has already been supplied, the supply may be continued or the amount of supply may be increased. If ink is also being supplied, the proportion of the ink and the diluent supplied may be changed. Then, the processing procedure ends.

Thus, disposing the concentration measuring unit 20 at the direction change portion 24 at which the ink flow direction changes in the channel 23 to measure the ink concentration allows high-accuracy measurement. Adjusting the ink concentration using the measurement result further increases the quality of the image recorded by the recording head 30.

### Second Embodiment

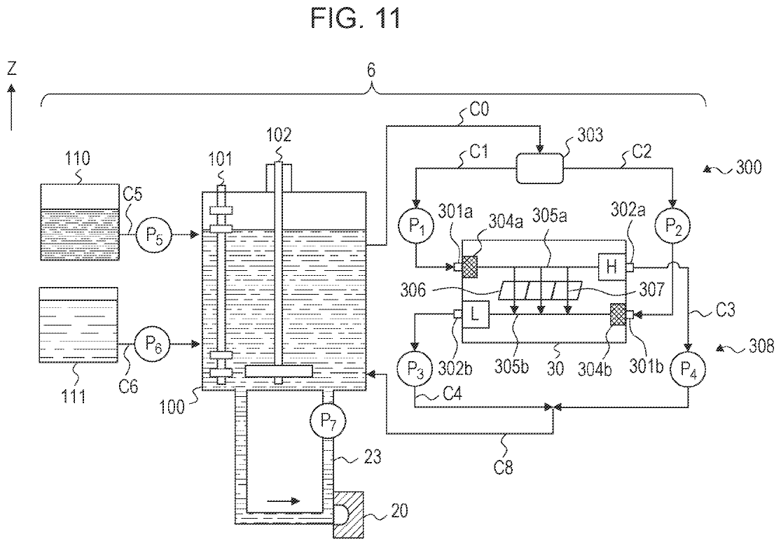

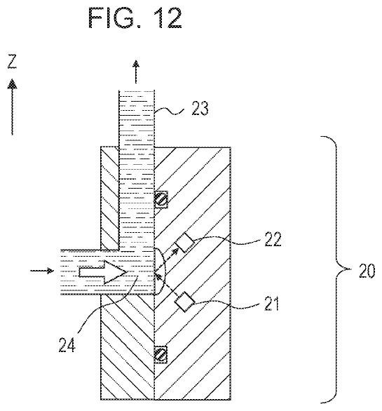

A configuration according to a second embodiment of the present disclosure will be described hereinbelow. Description will be omitted for the configuration overlapping with that of the first embodiment. FIG. 11 is a schematic diagram illustrating the detailed configuration of a supply unit 6 according to the second embodiment. FIG. 12 is an enlarged schematic diagram illustrating, in outline, the configuration of a concentration measuring unit 20 according to the second embodiment.

The concentration measuring unit 20 of the second embodiment is also disposed at a bent portion of the channel 23 at which the ink flow changes (a direction change portion 24). In the first embodiment, the ink flows at an angle both in and out from the concentration measuring unit 20. In the second embodiment, the ink flows at an angle into the concentration measuring unit 20 but flows at not angle out from the concentration measuring unit 20. However, the flow rate on the channel wall surface is higher at the bent portion of the channel 23 than at the straight portion. This reduces the adsorption and attachment of the ink component on the channel wall surface, as in the first embodiment.

### Third Embodiment

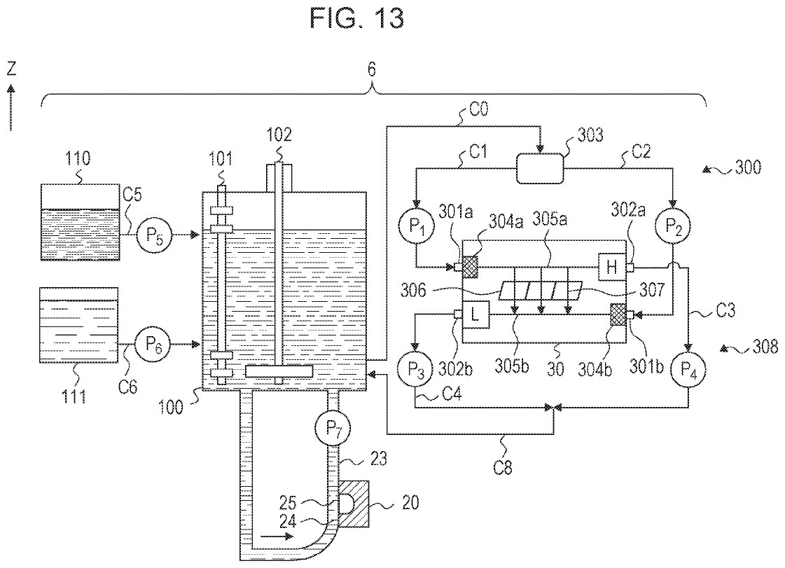

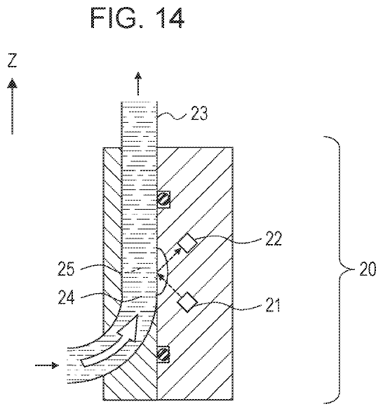

A configuration according to a third embodiment of the present disclosure will be described hereinbelow. Description will be omitted for the configuration overlapping with those of the first and second embodiments. FIG. 13 is a schematic diagram illustrating the detailed configuration of a supply unit 6 according to the third embodiment. FIG. 14 is an enlarged schematic diagram illustrating, in outline, the configuration of a concentration measuring unit 20 according to the third embodiment.

In the third embodiment, the concentration measuring unit 20 is disposed at a peripheral portion 25 downstream from the direction change portion 24, not at the direction change portion 24. This causes the ink that has increased in flow rate at the direction change portion 24 to flow through the peripheral portion 25, increasing the flow rate on the channel wall surface as compared the flow rate on the straight portion of the channel 23. Thus, also when the concentration measuring unit 20 is disposed at the peripheral portion 25 of the direction change portion 24, ink concentration can be measured at high accuracy. Although the peripheral portion 25 is disposed downstream from the direction change portion 24 by way of example, disposing the concentration measuring unit 20 upstream from the direction change portion 24 gives similar advantageous effects.

### Fourth Embodiment

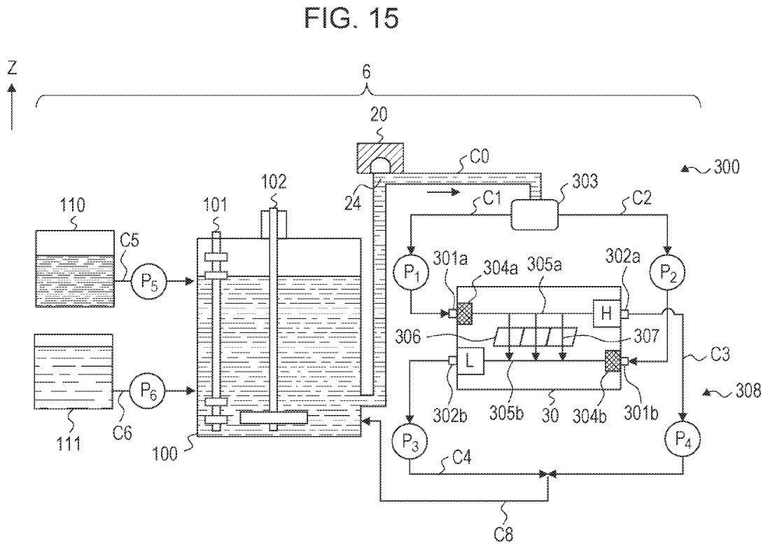

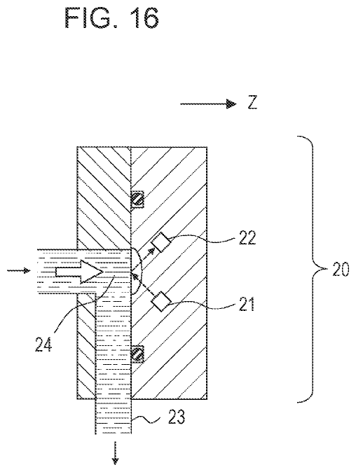

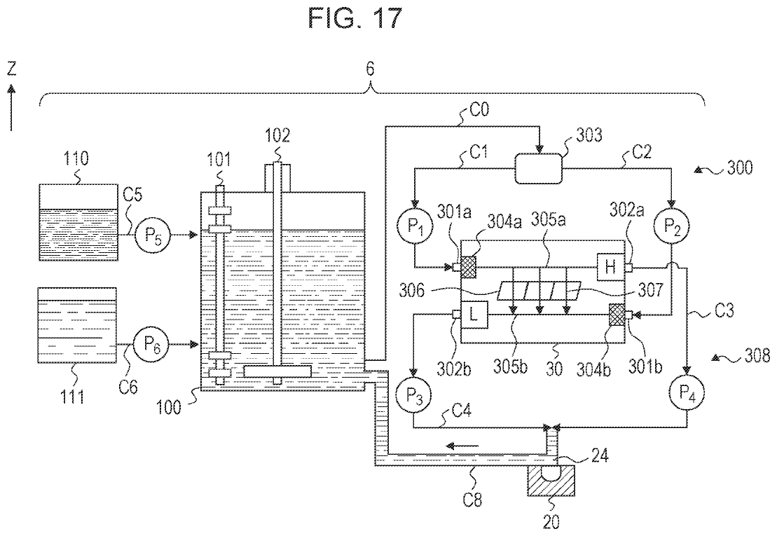

A configuration according to a fourth embodiment of the present disclosure will be described hereinbelow. Description will be omitted for the configuration overlapping with those of the first to third embodiments. FIG. 15 is a schematic diagram illustrating the detailed configuration of a supply unit 6 according to the fourth embodiment. FIG. 16 is an enlarged schematic diagram illustrating, in outline, the configuration of a concentration measuring unit 20 according to the fourth embodiment. FIG. 17 is a schematic diagram illustrating the detailed configuration of a supply unit 6 according to a modification of the fourth embodiment.

In the fourth embodiment, the concentration measuring unit 20 is disposed at a direction change portion 24 of the upstream supply channel C0 for supplying ink from the buffer tank 100 to the recording head 30. Thus, the channel at which the concentration measuring unit 20 is disposed is not limited to the channel 23 in the first to third embodiments. Disposing the concentration measuring unit 20 at the direction change portion 24 in which the ink flow direction changes or at the periphery thereof gives similar advantageous effects. Accordingly, also disposing the concentration measuring unit 20 at the direction change portion 24 of the downstream collecting channel C8 for collecting ink from the recording head 30 to the buffer tank 100, as shown in FIG. 17, gives similar advantageous effects.

### Fifth Embodiment

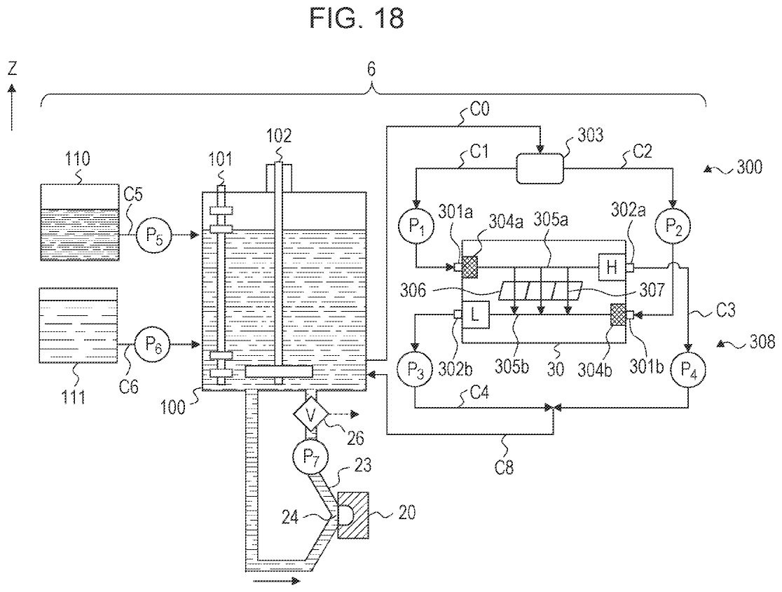

A configuration according to a fifth embodiment of the present disclosure will be described hereinbelow. Description will be omitted for the configuration overlapping with those of the first to fourth embodiments. FIG. 18 is a schematic diagram illustrating the detailed configuration of a supply unit 6 according to the fifth embodiment.

In the fifth embodiment, a three-way valve 26 connected to a waste-liquid container (not shown) is provided in the channel 23. When the ink concentration measured at the direction change portion 24 of the channel 23 is not within the predetermined range or when the ink in the recording apparatus 1A needs to be discharged, the ink can be discharged from the channel 23 by controlling the three-way valve 26.

### Sixth Embodiment

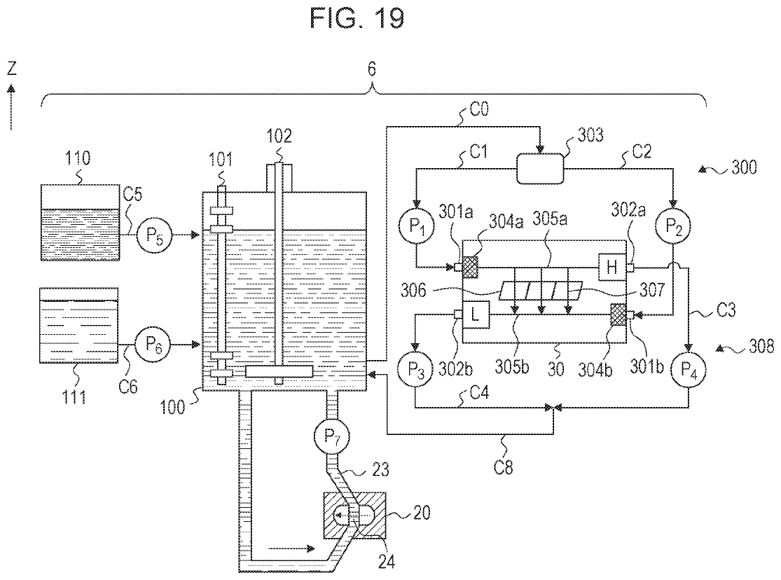

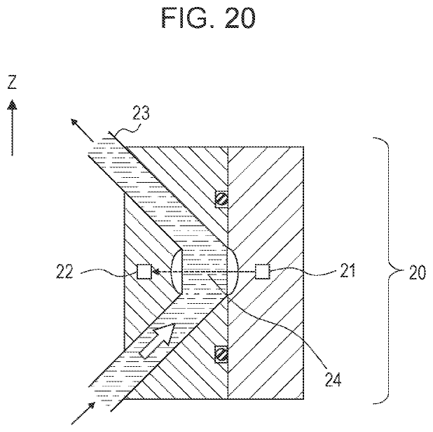

A configuration according to a sixth embodiment of the present disclosure will be described hereinbelow. Description will be omitted for the configuration overlapping with those of the first to fifth embodiments. FIG. 19 is a schematic diagram illustrating the detailed configuration of a supply unit 6 according to the sixth embodiment. FIG. 20 is an enlarged schematic diagram illustrating, in outline, the configuration of a concentration measuring unit 20 according to the sixth embodiment.

The concentration measuring unit 20 of the sixth embodiment is disposed at a position at which the light receiving unit 22 faces the light radiating unit 21 with the channel 23 (the direction change portion 24) therebetween. In other words, the concentration measuring unit 20 of the sixth embodiment measures the concentration on the basis of measurement data on forward-scattered light. Providing a light transmission area in the concentration measuring unit 20 in the channel 23 such that the light travels short distance through the ink allows the light receiving unit 22 to receive a sufficient amount of light even through ink with high absorbance, which allows measurement of high concentration ink.

### Other Embodiments

While the above embodiments illustrate a configuration in which the recording unit 3 includes a plurality of recording heads 30, a configuration in which the recording unit 3 includes only one recording head 30 may be employed. The recording head may be of a serial type that is mounted on a movable carriage and that ejects ink for recording while moving with the carriage.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2021-086091 filed May 21, 2021, which is hereby incorporated by reference herein in its entirety.

What is claimed is:

1. A recording apparatus comprising:
a channel through which liquid to be supplied to a recording head that ejects the liquid flows; and
a concentration measuring unit including a light emitting unit and a light receiving unit, the concentration measuring unit being configured to measure concentration of the liquid,
wherein the concentration measuring unit is disposed at a direction change portion of the channel at which the liquid flowing through the channel changes in direction.

2. The recording apparatus according to claim 1, further comprising:
a tank configured to store the liquid to be supplied to the recording head.
wherein the channel circulates the liquid between the tank and the concentration measuring unit.

3. The recording apparatus according to claim 1, further comprising:
a tank configured to store the liquid to be supplied to the recording head,
wherein the channel supplies the liquid from the tank to the recording head.

4. The recording apparatus according to claim 1, further comprising:
a tank configured to store the liquid to be supplied to the recording head,
wherein the liquid circulates between the recording head and the tank, and
wherein the channel collects the liquid from the recording head into the tank.

5. The recording apparatus according to claim 2, further comprising:
a supply unit configured to supply a diluent for decreasing the concentration of the liquid to the tank; and
a control unit configured, when a result of measurement performed by the concentration measuring unit is higher than a predetermined value, to cause the supply unit to supply the diluent to the tank.

6. The recording apparatus according to claim 2, further comprising:
a replenishing unit configured to replenish the tank with the liquid; and
a control unit configured, when a result of measurement performed by the concentration measuring unit has changed from a predetermined value, to cause the replenishing unit to replenish the tank with the liquid.

7. The recording apparatus according to claim 1, wherein the light receiving unit receives backward-scattered light of light emitted from the light emitting unit to the channel.

8. The recording apparatus according to claim 1, wherein the light receiving unit receives forward-scattered light of light emitted from the light emitting unit to the channel.

9. The recording apparatus according to claim 1, further comprising a control unit configured, when a result of measurement performed by the concentration measuring unit is higher than a predetermined value, to cause the liquid to be discharged from the channel.

10. The recording apparatus according to claim 1, wherein the concentration measuring unit measures the concentration while the liquid is flowing through the channel.

11. The recording apparatus according to claim 1, wherein the liquid is ink that contains pigment.

12. The recording apparatus according to claim 1, wherein the channel is made of a light transmissive material.

13. The recording apparatus according to claim 1, further comprising the recording head.
